(19) United States
(12) Patent Application Publication
(10) Pub. No.: US 2008/0035556 A1
(43) Pub. Date: Feb. 14, 2008

(54) PROCESS FOR PRODUCING FILM FORMING RESINS FOR PHOTORESIST COMPOSITIONS

(76) Inventors: Munirathna Padmanaban, Bridgewater, NJ (US); M. Dalil Rahman, Flemington, NJ (US)

Correspondence Address: ALAN P. KASS;AZ ELECTRONIC MATERIALS USA CORP., 70 MEISTER AVENUE, SOMERVILLE, NJ, 08876, US

(21) Appl. No.: 11/873,525

(22) Filed: Oct. 17, 2007

Related U.S. Application Data
(62) Division of application No. 10/988,246, filed on Nov. 12, 2004.

(51) Int. Cl. B01D 69/12; B01D 71/16; B01D 71/40

(52) U.S. Cl. 210/500.3; 210/500.21; 210/500.43; 210/504

(57) ABSTRACT

The present invention provides a method of reducing metals in solutions of film forming resins and a related filter sheet.

### CROSS-REFERENCE TO RELATED APPLICATION

This is a divisional of U.S. application Ser. No. 10/988,246, filed Nov. 12, 2004, the contents of which are incorporated herein by reference in its entirety.

The present invention provides a process for producing a film forming resin suitable for use in photoresist compositions. The process involves removing metal ion impurities from such a film forming resin by contacting a solution of film forming resin in a solvent having metal ion impurities with a functionalized silica gel as described hereinbelow. The present invention also provides a filter sheet comprising a self-supported fibrous matrix having immobilized therein a functionalized silica gel. The filter sheet can further comprise a particulate filter aid.

### BACKGROUND OF THE INVENTION

Photoresist compositions are used in microlithography processes for making miniaturized electronic components, such as in the fabrication of computer chips and integrated circuits. Generally, in these processes, a thin coating of a film of a photoresist composition is first applied to a substrate material, such as silicon wafers used for making integrated circuits. The coated substrate is then baked to evaporate any solvent in the photoresist composition and to fix the coating onto the substrate. The baked-coated surface of the substrate is next subjected to an image-wise exposure to radiation.

This radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation-exposed (in the case of positive photoresist) or the unexposed (in the case of negative photoresist) areas of the coated surface of the substrate.

Metal ion contamination has been a problem for a long time in the fabrication of high density integrated circuits, computer hard drives and computer chips, often leading to increased defects, yield losses, degradation and decreased performance. In plasma processes, metal ions such as sodium and iron, when they are present in a photoresist, can cause contamination especially during plasma stripping. However, these problems can be overcome to a substantial extent during the fabrication process, for example, by utilizing HCl gathering of the contaminants during a high temperature anneal cycle.

As electronic devices have become more sophisticated, these problems have become much more difficult to overcome. When silicon wafers are coated with a liquid positive photoresist and subsequently stripped off, such as with oxygen microwave plasma, the performance and stability of the semiconductor device is often seen to decrease because of the presence of what would be considered very low levels of metal ions. As the plasma stripping process is repeated, more degradation of the device frequently occurs. A primary cause of such problems has been found to be metal ion contamination in the photoresist, particularly sodium and iron ions. Metal ion levels of less than 100 ppb (parts per billion) in the photoresist have sometimes been found to adversely affect the properties of such electronic devices. Impurity levels in photoresist compositions have been and are currently controlled by (1) choosing materials for photoresist compositions which meet strict impurity level specifications and (2) carefully controlling the photoresist formulation and processing parameters to avoid the introduction of impurities into the photoresist composition. As photoresist applications become more advanced, tighter impurity specifications must be made.

Film forming resins (such as film forming novolak resins and vinylphenol resins) are frequently used a polymeric binder in liquid photoresist formulations. In producing sophisticated semiconductor and other microelectronic devices, it has become increasingly important to provide film forming resins having metal ion contamination levels below 50 ppb each. The present invention provides a method for producing such film forming resins having very low metal ion concentrations.

There are two types of photoresist compositions, negative-working and positive-working. When negative-working photoresist compositions are exposed image-wise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal of the non-exposed areas of the photoresist coating and the creation of a negative image in the coating thereby uncovering a desired portion of the underlying substrate surface on which the photoresist composition was deposited.

On the other hand, when positive-working photoresist compositions are exposed image-wise to radiation, those areas of the photoresist composition exposed to the radiation become more soluble to the developer solution (e.g. a rearrangement reaction occurs) while those areas not exposed remain relatively insoluble to the developer solution. Thus, treatment of an exposed positive-working photoresist with the developer causes removal of the exposed areas of the coating and the creation of a positive image in the photoresist coating. Again, a desired portion of the underlying substrate surface is uncovered.

After this development operation, the now partially unprotected substrate may be treated with a substrate-etchant solution or plasma gases and the like. The etchant solution or plasma gases etch that portion of the substrate where the photoresist coating was removed during development. The areas of the substrate where the photoresist coating still remains are protected and, thus, an etched pattern is created in the substrate material which corresponds to the photomask used for the image-wise exposure of the radiation. Later, the remaining areas of the photoresist coating may be removed during a stripping operation, leaving a clean etched substrate surface. In some instances, it is desirable to heat treat the remaining photoresist layer, after the development step and before the etching step, to increase its adhesion to the underlying substrate and its resistance to etching solutions.

Positive working photoresist compositions are currently favored over negative working resists because the former generally have better resolution capabilities and pattern transfer characteristics. Photoresist resolution is defined as the smallest feature which the resist composition can transfer from the photomask to the substrate with a high degree of image edge acuity after exposure and development. In many manufacturing applications today, resist resolution on the order of less than one micron is quite common. In addition, it is almost always desirable that the developed photoresist wall profiles be near vertical relative to the substrate. Such demarcations between developed and undeveloped areas of the resist coating translate into accurate pattern transfer of the mask image onto the substrate.

### SUMMARY OF THE INVENTION

The present invention relates to a filter sheet for filtering a photoresist composition comprising a self-supporting fibrous matrix having immobilized therein a functionalized silica gel, wherein the functionalized silica gel is distributed substantially uniformly throughout a cross-section of said matrix.

Examples of the functionalized silica gel include 3-aminopropyl-functionalized silica gel, 3-(diethylenetriamino)propyl-functionalized silica gel, 3-(ethylenediamino)propyl-functionalized silica gel, 2-(4-(ethylenediamino)benzyl)ethyl-functionalized silica gel, 3-(1-thioureido)propyl-functionalized silica gel, 3-(ureido)propyl-functionalized silica gel, 3-(dimethylamino)propyl-functionalized silica gel, 3-(4,4′-trimethylenedipiperidino)propyl, functionalized silica gel, 2-(2-pyridyl)ethyl-functionalized silica gel, 3-(1-piperazino)propyl-functionalized silica gel, 3-(1-piperidino)propyl, functionalized silica gel, 3-(imidazol-1-yl)propyl-functionalized silica gel, 3-(1-morpholino)propyl-functionalized silica gel, 3-(1,3,4,6,7,8,-hexahydro-2H-pyrimido-[1,2-a]pyrimidino)propyl, functionalized silica gel, tetraammonium acetate acid functionalized silica gel, 2-(4-benzyltrimethylammonium chloride)ethyl-functionalized silica gel, 3-(trimethylammonium) carbonate propyl-functionalized silica gel, and mixtures thereof.

The filter sheet of the present invention can further comprise a particulate filter aid.

The present invention also relates to a method for producing a film forming resin suitable for use in a photoresist composition, said method comprising the steps of: (a) providing a solution of a film forming resin in a solvent; (b) providing a functionalized silica gel; (c) contacting the solution of the film forming resin with the functionalized silica gel of (b); and (d) separating the solution of film forming resin from the functionalized silica gel, thereby producing the film forming resin suitable for use in a photoresist composition.

Contacting the solution of the film forming resin with the functionalized silica gel can be accomplished, for example, by passing the solution through a column containing the silica gel; or passing the solution of the film forming resin through the filter sheet of the present invention; or by mixing the solution and silica gel together (for example, in a bottle or flask put on a shaker or roller). The reins solution is collected separately from the silica gel as it passes through the column containing the silica gel or through the filter sheet. After the resin solution is mixed with the silica gel (e.g., by shaking or rolling in a bottle), the mixture can be filtered through a suitable filter where the silica gel will remain on the filter and the resin solution will pass through and collected in a suitable container.

In addition to passing the solution of film forming resin through the filter sheet of the present invention, the solution of film forming resin can also be filtered through at least one filter sheet selected from (i) a filter sheet comprising a self-supporting fibrous matrix having immobilized therein a particulate filter aid and a particulate ion exchange resin, said ion exchange resin having an average particle size of from about 2 to about 10 μm, wherein said particulate filter aid and ion exchange resin particles are distributed substantially uniformly throughout a cross-section of said matrix; and/or (ii) a filter sheet comprising a self-supporting matrix of fibers having immobilized therein a particulate filter aid and a binder resin, said filter sheet having an average pore size of 0.05 to 0.5 μm, where the filter sheet of (i) and/or (ii) is rinsed with the solvent of step (a). The solution of film forming resin is passed through one of the following: (A) filter sheet (i); (B) filter sheet (ii); (C) first through filter sheet (i) and then through filter sheet (ii); or (D) first through filter sheet (ii) and then through filter sheet (i). This can occur prior to and/or subsequent to passing the solution of film forming resin through the filter sheet of the present invention.

After passing the solution of film forming resin through the filter sheet of the present invention (that is, the one with functionalized silica gel immobilized therein), in one embodiment, the film forming resin of the present invention suitable for use in a photoresist composition has a concentration of sodium and iron ions that is less than 50 parts per billion (ppb) each, and in one embodiment less than 25 ppb, and in one embodiment, less than 10 ppb.

The present invention also relates to a method for producing a photoresist composition which comprises providing an admixture of: (1) a film forming resin prepared by the method of present invention; (2) a photosensitive component in an amount sufficient to photosensitize a photoresist composition; and (3) a suitable photoresist solvent.

The present invention also relates to a method for producing a microelectronic device by forming an image on a substrate which comprises (a) providing the photoresist composition prepared by the method of the present invention; (b) thereafter, coating a suitable substrate with the photoresist composition from step (a); (c) thereafter, heat treating the coated substrate until substantially all of the photoresist solvent is removed; and (d) imagewise exposing the photoresist composition and removing the imagewise exposed areas of the photoresist composition with a suitable developer.

### DETAILED DESCRIPTION OF THE INVENTION

The present invention relates to a filter sheet for filtering a photoresist composition comprising a self-supporting fibrous matrix having immobilized therein a functionalized silica gel, wherein the functionalized silica gel is distributed substantially uniformly throughout a cross-section of said matrix.

Examples of the functionalized silica gel include 3-aminopropyl-functionalized silica gel, 3-(diethylenetriamino)propyl-functionalized silica gel, 3-(ethylenediamino)propyl-functionalized silica gel, 2-(4-(ethylenediamino)benzyl)ethyl-functionalized silica gel, 3-(1-thioureido)propyl-functionalized silica gel, 3-(ureido)propyl-functionalized silica gel, 3-(dimethylamino)propyl-functionalized silica gel, 3-(4,4′-trimethylenedipiperidino)propyl, functionalized silica gel, 2-(2-pyridyl)ethyl-functionalized silica gel, 3-(1-piperazino)propyl-functionalized silica gel, 3-(1-piperidino)propyl, functionalized silica gel, 3-(imidazol-1-yl)propyl-functionalized silica gel, 3-(1-morpholino)propyl-functionalized silica gel, 3-(1,3,4,6,7,8,-hexahydro-2H-pyrimido-[1,2-a]pyrimidino)propyl, functionalized silica gel, tetraammonium acetate acid functionalized silica gel, 2-(4-benzyltrimethylammonium chloride)ethyl-functionalized silica gel, 3-(trimethylammonium) carbonate propyl-functionalized silica gel, and mixtures thereof.

The filter sheet of the present invention can further comprise a particulate filter aid.

The present invention also relates to a method for producing a film forming resin suitable for use in a photoresist composition, said method comprising the steps of: (a) providing a solution of a film forming resin in a solvent; (b) providing a functionalized silica gel; (c) contacting the solution of the film forming resin with the functionalized silica gel of (b); and (d) separating the solution of film forming resin from the functionalized silica gel, thereby producing the film forming resin suitable for use in a photoresist composition.

Contacting the solution of the film forming resin with the functionalized silica gel can be accomplished, for example, by passing the solution through a column containing the silica gel; or passing the solution of the film forming resin through the filter sheet of the present invention; or by mixing the solution and silica gel together (for example, in a bottle or flask put on a shaker or roller). The reins solution is collected separately from the silica gel as it passes through the column containing the silica gel or through the filter sheet. After the resin solution is mixed with the silica gel (e.g., by shaking or rolling in a bottle), the mixture can be filtered through a suitable filter where the silica gel will remain on the filter and the resin solution will pass through and collected in a suitable container.

In addition to passing the solution of film forming resin through the filter sheet of the present invention, the solution of film forming resin can also be filtered through at least one filter sheet selected from (i) a filter sheet comprising a self-supporting fibrous matrix having immobilized therein a particulate filter aid and a particulate ion exchange resin, said ion exchange resin having an average particle size of from about 2 to about 10 μm, wherein said particulate filter aid and ion exchange resin particles are distributed substantially uniformly throughout a cross-section of said matrix; and/or (ii) a filter sheet comprising a self-supporting matrix of fibers having immobilized therein a particulate filter aid and a binder resin, said filter sheet having an average pore size of 0.05 to 0.5 μm, where the filter sheet of (i) and/or (ii) is rinsed with the solvent of step (a). The solution of film forming resin is passed through one of the following: (A) filter sheet (i); (B) filter sheet (ii); (C) first through filter sheet (i) and then through filter sheet (ii); or (D) first through filter sheet (ii) and then through filter sheet (i). This can occur prior to and/or subsequent to passing the solution of film forming resin through the filter sheet of the present invention.

After passing the solution of film forming resin through the filter sheet of the present invention (that is, the one with functionalized silica gel immobilized therein), in one embodiment, the film forming resin of the present invention suitable for use in a photoresist composition has a concentration of sodium and iron ions that is less than 50 parts per billion (ppb) each, and in one embodiment less than 25 ppb, and in one embodiment, less than 10 ppb.

The present invention also relates to a method for producing a photoresist composition which comprises providing an admixture of: (1) a film forming resin prepared by the method of present invention; (2) a photosensitive component in an amount sufficient to photosensitize a photoresist composition; and (3) a suitable photoresist solvent.

The present invention also relates to a method for producing a microelectronic device by forming an image on a substrate which comprises (a) providing the photoresist composition prepared by the method of the present invention; (b) thereafter, coating a suitable substrate with the photoresist composition from step (a); (c) thereafter, heat treating the coated substrate until substantially all of the photoresist solvent is removed; and (d) imagewise exposing the photoresist composition and removing the imagewise exposed areas of the photoresist composition with a suitable developer.

The filter sheet of this invention is comprised of an amount of a functionalized silica gel and, in some instances can contain a particulate filter aid, immobilized in a substantially inert porous matrix. The filter sheet of this invention contains extremely small amounts, i.e., very low parts per billion (ppb) levels, of extractable metal impurities which can be introduced into filtrates such as photoresist compositions. As a result, the filter sheet of the invention is particularly useful in the purification of photoresist compositions.

The porous matrix may be any matrix material capable of immobilizing the functionalized silica gel and, when present, the particulate filter aid contained therein, i.e. one capable of preventing loss of the functionalized silica gel and, when present, the particulate filter aid from the filter sheet. The filter sheet possesses a porosity which enables the fluid being filtered to pass through the filter while entrapping or retaining captured particulate contaminants and dissolved ionic contaminants. In order to provide a matrix which is a coherent and a handleable structure, it is desirable that at least one of the components which go into forming the porous matrix be a long, self-bonding structural fiber. Such fiber gives the filter sheet sufficient structural integrity in both the wet “as formed” condition and in the final dried condition. Such a structure permits handling of the filter media during processing and at the time of its intended use. Suitable fibers which may be utilized in the present invention include polyacrylonitrile fibers, nylon fibers, rayon fibers, polyvinyl chloride fibers, cellulose fibers, such as wood pulp and cotton, and cellulose acetate fibers.

One embodiment of the filter sheet of this invention possesses a porous matrix comprised of a self-bonding matrix of cellulose fibers. Such fibers can represent from about 15 to about 80 weight percent, another embodiment being from about 40 to about 70 weight percent, of the filter sheet of this invention. Where cellulose fibers are employed in the fabrication of the filter sheet of this invention, a major portion, i.e., greater than 50 percent, of the cellulose fibers is preferably composed of normally dimensioned cellulose pulp, having a Canadian Standard Freeness of +400 to +800 ml. (hereinafter “normal cellulose pulp”). These fibers are typically relatively large, with commercially available diameters in the range of about 10 to about 60 microns and fiber lengths of from about 0.85 to about 6.5 mm. The minor portion, i.e., less than 50 percent, of the cellulose fibers, is refined pulp, exhibiting a Canadian Standard Freeness of +100 to −1000 ml. Such blends of normal cellulose pulp and refined cellulose pulp advantageously yield filter sheets in which the retention of particulate filter aid and particulate ion exchange resin is improved as compared to filter sheets prepared from normal cellulose pulp only. In a highly preferred embodiment of the present invention, a special grade of cellulose pulp is employed which possesses greater purity and greater carboxyl functionality compared to conventional grades of cellulose pulp. Such special grades are available commercially under the tradename MAC Sulphite, AA Sulphite and Alpha Hardwood Sulphite (Weyerhaeuser). The use of MAC Sulphite pulp is preferred in the practice of the present invention. Typical characteristics of a highly purified cellulose pulp which can be advantageously employed in the practice of the present invention are as follows:

| Property | Range | Preferred Range |
|---|---|---|
| Brightness %¹ | 90-95 | 93-95 |
| Dirt (mm²/m²)² | 0.5-3 | 0.5-1 |
| Iron extractables (mg/kg) | 1-14 | 1-3 |
| Calcium extractables (mg/kg) | 50-300 | 50-100 |
| Copper extractables (mg/kg) | 0.1-5.0 | 0.1-0.5 |
| Manganese extractables (mg/kg) | 0.1-0.5 | 0.1-0.2 |

¹TAPPI
²TAPPI

High purity cellulose pulps possess alpha-cellulose contents ranging from about 90 to about 95 percent and can be produced by the well-known and preferred sulphite process. Cellulose pulps possessing alpha-cellulose contents of greater than about 90 percent and high carboxyl functionality are useful in the practice of the present invention.

The state of refinement of a cellulose fiber is determined by means of a “freeness” test in which measurement of the flow rate through a forming pad of the cellulose fiber on a standard screen is determined. Two of the most common instruments for the measurement of freeness are the “Canadian Standard Freeness Tester” and the “Schopper-Riegler Freeness Tester”. In both of these methods, the quantity which is measured is the volume of water (expressed in ml) which overflows from a receiver containing an orifice outlet at the bottom. The Canadian Standard Freeness measurements are employed in the present specification. Coarse, unbeaten cellulose pulp, i.e., normal cellulose pulp, produces high drainage rates into the receiver from the screen resulting in large overflow volumes, and hence yields high freeness. Normal cellulose pulp exhibits Canadian Standard Freeness values ranging from +400 ml to +800 ml. Such pulp may be subjected to mechanical refining processes, i.e., beating, which cuts and/or fibrillates the cellulose fibers. Such refined fibers exhibit slower drainage rates, and, therefore, lower freeness values, i.e., in the range of +100 to −1000 ml. As refining is continued, the quantity of freeness in the overflow increases as more and more of the material passes through the screen. The freeness in this range is described as “inverted” and, for convenience, is accorded a negative value. By use of special refining equipment and long refining time, it is possible to achieve inverted Canadian Standard Freeness values of up to −1000 ml. There are several types of pulp refiners commercially available and these fall into two basic categories, namely, conical or jordan types, and disc types. The disc types, especially double-disc refiners, appear to be particularly suitable for the preparation of refined pulps.

Normal cellulose fibers can represent about 15 to about 80 weight percent of the filter sheet, with from about 15 to about 40 weight percent being another embodiment, from about 25 to about 40 weight percent being yet another embodiment and from about 30 to about 40 weight percent being still yet another embodiment, to provide a filter sheet structural characteristics suitable for photoresist filtration applications. Refined cellulose pulp can represent from about 0 to about 45 weight percent of the filter sheet of this invention, with from about 5 to about 40 weight percent being another embodiment, from about 10 to about 30 weight percent being yet another embodiment and from about 20 to about 30 weight percent being still yet another embodiment.

The use of refined pulp surprisingly results in a significant improvement in ion exchange capacity and a concomitant improvement in retention of particulates. Generally, the weight ratio of normal to refined pulp utilized in the practice of the present invention will range from about 1:1 to about 10:1, another embodiment being from about 1.2:1 to about 3:1.

Examples of the functionalized silica gel include, but are not limited to, 3-aminopropyl-functionalized silica gel, 3-(diethylenetriamino)propyl-functionalized silica gel, 3-(ethylenediamino)propyl-functionalized silica gel, 2-(4-(ethylenediamino)benzyl)ethyl-functionalized silica gel, 3-(1-thioureido)propyl-functionalized silica gel, 3-(ureido)propyl-functionalized silica gel, 3-(dimethylamino)propyl-functionalized silica gel, 3-(4,4′-trimethylenedipiperidino)propyl, functionalized silica gel, 2-(2-pyridyl)ethyl-functionalized silica gel, 3-(1-piperazino)propyl-functionalized silica gel, 3-(1-piperidino)propyl, functionalized silica gel, 3-(imidazol-1-yl)propyl-functionalized silica gel, 3-(1-morpholino)propyl-functionalized silica gel, 3-(1,3,4,6,7,8,-hexahydro-2H-pyrimido-[1,2-a]pyrimidino)propyl, functionalized silica gel, tetraammonium acetate acid functionalized silica gel, 2-(4-benzyltrimethylammonium chloride)ethyl-functionalized silica gel, 3-(trimethylammonium) carbonate propyl-functionalized silica gel, and mixtures thereof. One supplier of such functionalized silica gels is Silicycle, Quebec, Canada.

Typically, the filter sheet will contain from about 5 to about 70 weight percent of the functionalized silica gel.

Performance of the filter sheet containing the functionalized silica gel can be enhanced by adding an amount of particulate filter aid in the filter sheet of the invention. While as little as about 2 percent of a particulate filter aid will result in noticeable improvement in filtration performance, optimum performance is achieved by utilizing the maximum amount of particulate filter aid consistent with the aforementioned requirements for certain amounts of normal and refined wood pulp. For filtration of photoresist compositions, structural characteristics suggest employing a practicable maximum of about 45 percent by weight particulate filter aid. Of course, for less demanding applications, somewhat higher levels will be possible. Generally, levels of from about 15 to about 40 percent by weight particulate filter aid can be employed. In accordance with another embodiment, the particulate filter aid is acid washed to remove metal impurities on the surfaces thereof. The acid can be any of hydrochloric acid, formic acid, acetic acid, propionic acid, butyric acid, oxalic acid, succinic acid, sulfonic acid, nitric acid, and the like. For example, particulate filter aid can be soaked in an HCl solution at pH of about 2 for 5-6 hours to remove metal impurities.

There are various types of particulate filter aids that can be advantageously employed in the practice of the present invention including diatomaceous earth, magnesia, perlite, talc, colloidal silica, polymeric particulates such as those produced by emulsion or suspension polymerization, e.g., polystyrene, polyacrylates, poly(vinyl acetate), polyethylene, (or other such materials as described in Emulsions and Emulsion Technology, Lissant, Kenneth J., Marcel Dekker, 1974), activated carbon, molecular sieves, clay, and the like. Functionally, the particulate filter aids that can be used in the present invention should have a specific surface area in excess of about 1.0 m²/g and/or particle diameters of less than about 15 microns, preferably less than about 10 microns, more preferably less than about 5 microns. In a broad sense, any conventional particulate filter aid can be employed (such as J.N. Filter Cel, Standard Super Cel, Celite 512, Hydro Super Cel, Speed Plus and Speedflow, Dicalite 215 and Dicalite 416 and Dicalite 436). From the standpoint of size, morphology, cost, fluid compatibility and general performance characteristics, the finer grades of diatomaceous earth and perlite particulate filter aids exhibiting a mean particle size of less than about 10 microns are preferred. Mixtures of more than one type of particulate filter aid can be employed where desired, e.g., to provide better filtration performance and/or better cost/performance characteristics than that achieved by the use of any single type by itself. Similarly, mixtures of relatively coarse and fine particulate filter aids may be utilized in the practice of the present invention.

To fabricate the filter sheet of the present invention, a slurry of fibers, functionalized silica gel, and optionally particulate filter aid, is formed. The sequence of adding these components to water to form the initial slurry appears to be relatively unimportant. The consistency of the slurry will represent the highest possible for a practical suspension of the components, usually less than about 4 percent, preferably less than about 3 percent, solids. The system is subjected to hydrodynamic shear forces utilizing well known techniques, e.g., a bladed mixer. Any suitable shear rate or shear stress may be employed to break up any flocs and maintain the system in a dispersed condition. Of course, upon the formation of a disperse slurry, the system is free of floc formation even in the absence of applied shear. To control the dispersion characteristics of negatively charged self-bonding fibers such as cellulose fibers and/or negatively charged particulate filter aid, if used, and to improve wet strength, binder resins are advantageously employed in the formation of the filter sheet of this invention. Such binder resins may be organic or inorganic polymers. Binder resins improve particulate retention and improve the strength of the filter sheet of this invention while in the wet or dry state. One or more of the fibers, particulate filter aid (if used) can be pretreated with a binder resin prior to formation of the slurry or, preferably, the binder resin can be added to the slurry to facilitate the dispersion of self-bonding fibers and/or particulate filter aid in the slurry.

The slurry is diluted with additional water if necessary to the proper consistency required for vacuum felting sheet formation, ordinarily 1 to 2½ percent solids, depending upon the type of equipment used to form the sheet, in a manner known in the art. The slurry is cast onto a sheet and air dried in a standard manner. The method of drying is not critical, although faster drying sequences are preferred, hence elevated temperatures up to the decomposition or scorch point for the system are employed.

Another embodiment involves placing an amount of functionalized silica gel into an appropriately sized column, passing the solution containing film forming resin through the column and collecting the filtered film forming resin which has passed through the column filled with the functionalized silica gel.

Another embodiment involves placing an amount of functionalized silica gel in a container and then introducing an amount of the solution containing film forming resin into the container and then mixing the functionalized silica gel and film forming resin together for a period of time and then filtering the mixture to recover the film forming resin.

As with the filter sheet, the amount of functionalized silica gel used in either the column or mixing directly with the solution of film forming resin will be from about 2 to about 45 weight percent, or more if necessary, depending upon the volume of solution of film forming resin to be treated.

With regard to solutions of film forming resins that can be treated under this invention, those resins that are typically used in the photoresist field can be treated as provided for in this application. These resins include photoresists, bottom anti-reflective coatings, top anti-reflective coatings, and the like.

### EXAMPLES

### Example 1

A 100 ml bed volume column was filled with 3-(diethylenetriamino)propyl-functionalized silica gel (Si-Triamine from Silicycle). The column was washed with electronic grade propylene glycol monomethyl ether acetate (PGMEA). Thereafter, a 10 weight percent resin solution of poly(2-methyl-2-adamantyl methacrylate-co-3-hydroxy-1-methacryloxyadamantane-co-β-gamma-butyrolactone methacrylate) in PGMEA was passed through the column. The trace metals data of the PGMEA and the resin solution are shown below.

| | PGMEA before | PGMEA after | Resin solution | Resin solution |
|---|---|---|---|---|
| | filtering | filtering | before filtering | after filtering |
| Metal | ppb | ppb | ppb | ppb |
| Na | <1 | <1 | 9 | 8 |
| K | <1 | <1 | 13 | 2 |
| Fe | 2 | <1 | 7 | 2 |
| Cr | <1 | <1 | <1 | <1 |
| Cu | <1 | <1 | 2 | <1 |
| Ni | <1 | <1 | <1 | <1 |
| Ca | <1 | <1 | 16 | 3 |
| Al | <1 | <1 | 1 | <1 |
| Mg | <1 | <1 | 5 | 1 |
| Mn | <1 | <1 | 2 | <1 |
| Zn | <1 | <1 | 16 | 10 |

### Example 2

Example 1 was repeated for the resin solution and the resulting filtrate was measured for gel using GPC MALS technique. It was found that the amount of gel prior to passing the resin solution through the column was 724 and after passing through the column was 6.6. The use of the functionalized silica gel has an added benefit of reducing gels in polymer solutions.

### Example 3A

A photoresist solution was prepared by mixing the resin solution of Example 1 which had been passed through the column containing functionalized silica gel; FC-4430 fluorosurfactant (from 3M); base; triphenylsulfonium nonaflate; 4-hydroxy-3,5-dimethylphenyldimethylsulfonium nonaflate; and solvent (PGMEA/PGME).

### Example 3B

A photoresist solution was prepared by mixing resin solution of Example 1 which had not been passed through the column containing functionalized silica gel; FC-4430 fluorosurfactant (from 3M); base; triphenylsulfonium nonaflate; 4-hydroxy-3,5-dimethylphenyldimethylsulfonium nonaflate; and solvent (PGMEA/PGME).

### Example 4

Silicon substrates coated with a bottom antireflective coating (B.A.R.C.) were prepared by spin coating the B.A.R.C. solution (AZ® EXP ArF-1 B.A.R.C. available from Clariant Corporation, Somerville, N.J.) onto the silicon substrate and baked at 175° C. for 60 sec. The B.A.R.C film thickness was 37 nm. The photoresist solution from Example 3A was then coated onto one B.A.R.C coated silicon substrate and the photoresist solution from Example 3B was onto another B.A.R.C. coated silicon substrate. The spin speed was adjusted such that the photoresist film thickness was 150 nm. The photoresist film was baked at 140° C. for 60 sec. The substrates were then exposed in a Nikon 306C, 0.78NA & Dipole X illumination. PAB 140° C./60 sec; PEB 130° C. for 60 sec (development time 60 s (ACT12), 6% PSM). The imaged photoresists were then developed using a 2.38 weight % aqueous solution of tetramethyl ammonium hydroxide for 30 sec. The line and space patterns were then observed on a scanning electron microscope. The photoresist of Example 3A had good bright field (32.5 mJ/cm²) and linearity (41.5 mJ/cm²) as compared to Example 3B, which had bright field (43.0 mJ/cm²) and linearity (53.5 mJ/cm²).

### Example 5

Example 1 can be repeated except that instead using a column, 3 weight percent of 3-(diethylenetriamino)propyl-functionalized silica gel (Si-Triamine from Silicycle), based on the resin solution, can be mixed with a 10 weight percent resin solution of poly(2-methyl-2-adamantyl methacrylate-co-3-hydroxy-1-methacryloxyadamantane-co-β-gamma-butyrolactone methacrylate), both in PGMEA, in a container which is then shaken or rolled. After shaking or rolling, the mixture is filtered and the resin solution is obtained and expected to have similar results.

### Example 6

Example 2 can be repeated with resin solution from Example 5 to obtain similar results.

### Example 7

Example 3A can be repeated with resin solution from Example 5 to obtain similar results.

### Example 8

Example 4 can be repeated with the photoresist solution from Example 7 to obtain similar results.

### Example 9

Examples 5 to 8 can be repeated with a 10 weight percent resin solution of any of the following polymers in PGMEA with similar results: poly(t-butylnorbonene carboxylate-co-maleic anhydride-co-2-methyl-2-adamantyl methacrylate-co-β-gamma-butyrolactone methacrylate-co-methacryloxy norbornene-butyrolactone); poly(2-methyl-2-adamantyl methacrylate-co-2-ethyl-2-adamantyl methacrylate-co-3-hydroxy-1-methacryloxyadamantane-co-α-gamma-butyrolactone methacrylate); poly(2-ethyl-2-adamantyl methacrylate-co-3-hydroxy-1-methacryloxyadamantane-co-β-gamma-butyrolactone methacrylate); poly(2-methyl-2-adamantyl methacrylate-co-3-hydroxy-1-methacryloxyadamantane-co-β-gamma-butyrolactone methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-ethyl-2-adamantyl methacrylate-co-3-hydroxy-1-adamantyl acrylate-co-β-gamma-butyrolactone methacrylate); poly(2-ethyl-2-adamantyl methacrylate-co-3-hydroxy-1-adamantyl acrylate-co-α-gamma-butyrolactone methacrylate-co-tricyclo[5,2,1,0^{2,6}]deca-8-ylmethacrylate); poly(2-methyl-2-adamantyl methacrylate-co-3,5-dihydroxy-1-methacryloxyadamantane-co-α-gamma-butyrolactone methacrylate); poly(2-methyl-2-adamantyl methacrylate-co-3,5-dimethyl-7-hydroxy adamantyl methacrylate-co-α-gamma-butyrolactone methacrylate); poly(2-methyl-2-adamantyl acrylate-co-3-hydroxy-1-methacryloxyadamantane-co-α-gamma-butyrolactone methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-β-gamma-butyrolactone methacrylate-co-3-hydroxy-1-methacryloxyadamantane-co-ethylcyclopentylacrylate); poly(2-methyl-2-adamantyl methacrylate-co-3-hydroxy-1-adamantyl acrylate-co-α-gamma-butyrolactone methacrylate); poly(2-methyl-2-adamantyl methacrylate-co-3-hydroxy-1-methacryloxyadamantane-co-α-gamma-butyrolactone methacrylate-co-2-ethyl-2-adamantyl methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-ylmethacrylate); poly(2-methyl-2-adamantyl methacrylate-co-2-ethyl-2-adamantyl methacrylate-co-β-gamma-butyrolactone methacrylate-co-3-hydroxy-1-methacryloxyadamantane); poly(2-methyl-2-adamantyl methacrylate-co-2-ethyl-2-adamantyl methacrylate-co-α-gamma-butyrolactone methacrylate-co-3-hydroxy-1-methacryloxyadamantane).

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A filter sheet for filtering a photoresist composition comprising a self-supporting fibrous matrix having immobilized therein a functionalized silica gel, wherein the functionalized silica gel is distributed substantially uniformly throughout a cross-section of said matrix.

2. The filter sheet of claim 1 wherein the functionalized silica gel is selected from the group consisting of 3-aminopropyl-functionalized silica gel, 3-(diethylenetriamino)propyl-functionalized silica gel, 3-(ethylenediamino)propyl-functionalized silica gel, 2-(4-(ethylenediamino)benzyl)ethyl-functionalized silica gel, 3-(1-thioureido)propyl-functionalized silica gel, 3-(ureido)propyl-functionalized silica gel, 3-(dimethylamino)propyl-functionalized silica gel, 3-(4,4′-trimethylenedipiperidino)propyl, functionalized silica gel, 2-(2-pyridyl)ethyl-functionalized silica gel, 3-(1-piperazino)propyl-functionalized silica gel, 3-(1-piperidino)propyl, functionalized silica gel, 3-(imidazol-1-yl)propyl-functionalized silica gel, 3-(1-morpholino)propyl-functionalized silica gel, 3-(1,3,4,6,7,8,-hexahydro-2H-pyrimido-[1,2-a]pyrimidino)propyl, functionalized silica gel, tetraammonium acetate acid functionalized silica gel, 2-(4-benzyltrimethylammonium chloride)ethyl-functionalized silica gel, 3-(trimethylammonium) carbonate propyl-functionalized silica gel, and mixtures thereof.

3. The filter sheet of claim 1, wherein the self-supporting fibrous matrix are selected from the group consisting of polyacrylonitrile fiber, nylon fiber, rayon fiber, polyvinyl chloride fiber, cellulose fiber and cellulose acetate fiber.

4. The filter sheet of claim 3, wherein the self-supporting matrix of fibers are cellulose fibers.

4. The filter sheet of claim 1, wherein the filter sheet has an average pore size of about 0.2 to 1.0 micrometers (μm).

5. The filter sheet of claim 1, wherein the filter sheet has an average pore size of about 0.5 to 1.0 μm.

6. The filter sheet of claim 1 which further comprises a particulate filter aid.

7. The filter sheet of claim 6 wherein the particulate filter aid is selected from the group consisting of particulate filter aid is selected from the group consisting of diatomaceous earth, magnesia, perlite, talc, colloidal silica, polymeric particulates, activated carbon, molecular sieves, clay and mixtures thereof.

8. The method of claim 6, wherein the particulate filter aid of filter sheet (i) is acid washed.

9. The method of claim 8, wherein the acid is at least one member selected from the group consisting of hydrochloric acid, formic acid, acetic acid, propionic acid, butyric acid, oxalic acid, succinic acid, sulfonic acid, and nitric acid.

10. The filter sheet of claim 6 wherein the filter sheet contains from about 2 to about 45 weight percent particulate filter aid.

11. The filter sheet of claim 1 wherein the filter sheet contains from about 15 to about 80 weight percent fibrous matrix.

12. The filter sheet of claim 1 wherein the filter sheet contains from about 5 to about 70 weight percent functionalized silica gel.

13. A filter sheet for filtering a photoresist composition comprising a self-supporting fibrous matrix having immobilized therein a functionalized silica gel and a particulate filter aid, wherein the functionalized silica gel and the particulate filter aid are distributed substantially uniformly throughout a cross-section of said matrix.

14. The filter sheet of claim 13 wherein the functionalized silica gel is selected from the group consisting of 3-aminopropyl-functionalized silica gel, 3-(diethylenetriamino)propyl-functionalized silica gel, 3-(ethylenediamino)propyl-functionalized silica gel, 2-(4-(ethylenediamino)benzyl)ethyl-functionalized silica gel, 3-(1-thioureido)propyl-functionalized silica gel, 3-(ureido)propyl-functionalized silica gel, 3-(dimethylamino)propyl-functionalized silica gel, 3-(4,4′-trimethylenedipiperidino)propyl, functionalized silica gel, 2-(2-pyridyl)ethyl-functionalized silica gel, 3-(1-piperazino)propyl-functionalized silica gel, 3-(1-piperidino)propyl, functionalized silica gel, 3-(imidazol-1-yl)propyl-functionalized silica gel, 3-(1-morpholino)propyl-functionalized silica gel, 3-(1,3,4,6,7,8,-hexahydro-2H-pyrimido-[1,2-a]pyrimidino)propyl, functionalized silica gel, tetraammonium acetate acid functionalized silica gel, 2-(4-benzyltrimethylammonium chloride)ethyl-functionalized silica gel, 3-(trimethylammonium) carbonate propyl-functionalized silica gel, and mixtures thereof.

15. The filter sheet of claim 13, wherein the self-supporting fibrous matrix are selected from the group consisting of polyacrylonitrile fiber, nylon fiber, rayon fiber, polyvinyl chloride fiber, cellulose fiber and cellulose acetate fiber.

16. The filter sheet of claim 15, wherein the self-supporting matrix of fibers are cellulose fibers.

17. The filter sheet of claim 13, wherein the filter sheet has an average pore size of about 0.2 to 1.0 μm.

18. The filter sheet of claim 13, wherein the filter sheet containing the functionalized silica gel has an average pore size of about 0.5 to 1.0 μm.

19. The filter sheet of claim 13 wherein the particulate filter aid is selected from the group consisting of particulate filter aid is selected from the group consisting of diatomaceous earth, magnesia, perlite, talc, colloidal silica, polymeric particulates, activated carbon, molecular sieves, clay and mixtures thereof.

20. The filter sheet of claim 13, wherein the particulate filter aid of filter sheet (i) is acid washed.

21. The filter sheet of claim 20, wherein the acid is at least one member selected from the group consisting of hydrochloric acid, formic acid, acetic acid, propionic acid, butyric acid, oxalic acid, succinic acid, sulfonic acid, and nitric acid.

22. The filter sheet of claim 13 wherein the filter sheet contains from about 2 to about 45 weight percent particulate filter aid.

23. The filter sheet of claim 13 wherein the filter sheet contains from about 15 to about 80 weight percent fibrous matrix.

24. The filter sheet of claim 13 wherein the filter sheet contains from about 5 to about 70 weight percent functionalized silica gel.
